(19) United States
(12) Patent Application Publication
(10) Pub. No.: US 2007/0038807 A1
(43) Pub. Date: Feb. 15, 2007

(54) Reduced stress relaxation in elastomeric compression structures adapted for use with electrical components

(75) Inventors: Joseph Kuczynski, Rochester, MN (US); Kevin Albert Splittstoesser, Stewartville, MN (US); Timothy Jerome Tofil, Rochester, MN (US); Paul Alan Vermilyea, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/201,967

(22) Filed: Aug. 11, 2005

(51) Int. Cl. G06F 13/28

(52) U.S. Cl. 711/117

(57) ABSTRACT

Disclosed are enhanced methods and elastomeric compression structures utilizing embedded gas-filled gas-filled polymeric microspheres that are expanded in predefined conditions that are usable in electrical components for reducing stress relaxation.

### BACKGROUND OF THE INVENTION

The present invention is directed generally towards methods and structures used for minimizing and/or eliminating stress relaxation, particularly in elastomeric compression structures that are particularly adapted for use with electrical components.

Connectors are in widespread use in the electronics industry. One class of electrical connectors uses contact members on a ribbon cable. The contact members are pressed against contact fingers on a printed circuit board. Pressure is exerted on the back of the ribbon cable by an elastomeric compression structure or mat having compression fingers that are aligned with the contact members and contact fingers. The compression structure or mat is clamped to the printed circuit board. The compression structure or mat and its compression fingers are made of elastomeric materials, and the compression fingers act somewhat as springs. When the clamping arrangement is tightened, the compression fingers are placed under a state of compression and bulge outwardly.

Connectors of this latter type have a drawback in that the elastomeric materials of the compression structure or mat have a tendency to relax after the clamping arrangement has been tightened to a desired state. The compression fingers bulge outward and assume a shape that becomes more barrel-like with the passage of time. The relaxation of the material reduces the pressure forcing the contact members against the connector fingers, and thus may lead to faulty connections.

One might consider adjusting the geometry configurations or hardness of an elastomeric compression structure or mat in an attempt to minimize this stress relaxation. However, as the hardness of an elastomeric compression structure or mat increases, so does the actuation load required to compress the compression fingers to the necessary degree. Furthermore, attempts might be made to shorten the compression fingers in an attempt to minimize stress relaxation, but short, compression fingers pose reliability concerns due to assembly tolerance stack (e.g., compression fingers that are not quite long enough but are still within tolerance may not press the contact members against the contact fingers with sufficient force to ensure a reliable connection). Still another known approach employs restrainers about the compression fingers for minimizing stress relaxation of the compression fingers.

While known prior art stress relaxation management approaches perform adequately, there are nevertheless ongoing efforts to provide for even more reliable and low cost approaches for reducing or eliminating the effects of stress relaxation in supporting structures.

### SUMMARY OF THE INVENTION

The present invention provides enhanced methods and structures that are for reducing stress relaxation issues and that are particularly adapted for use in electrical connections without negative effect.

Aspects of the present invention include embodiments for enhanced methods and structures for forming an elastomeric compression structure. The methods and structures comprise providing a formulation including a base elastomer and a plurality of gas-expandable members dispersed within the base elastomer, wherein the gas-expandable members remain substantially unexpanded while the formulation is cured in a predefined curing temperature range; loading the cured formulation under compression and, heating the loaded formulation to operating temperatures in which the loaded formulation operates to cause the base elastomer and the gas-expandable members to expand by an amount sufficient to reduce stress relaxation of the loaded formulation.

These and other aspects of the present invention will be more fully understood from the following detailed description of the preferred embodiments, which should be read in light of the accompanying drawings. It should be understood that both the foregoing description and the following detailed description are exemplary and not restrictive.

### BRIEF DESCRIPTION OF THE DRAWINGS

FIG. 1 is a top view schematically illustrating two printed circuit boards and a ribbon cable that connects them by way of two connectors in accordance with the present invention.

FIG. 2 is a top view of a contact region on a broken-away portion of one of the printed circuit boards shown in FIG. 1.

FIG. 3 is a bottom view of a contact region on a broken-away portion of the ribbon cable shown in FIG. 1.

FIG. 4 is a cross-sectional view of a connector in accordance with the present invention.

FIG. 5A illustrates a schematic cross-sectional view of an elastomeric compression structure made in accordance with the present invention in a cured condition with the gas-filled polymeric microspheres unexpanded.

FIG. 5B illustrates a schematic cross-sectional view of the elastomeric compression structure in a loaded and unexpanded condition made in accordance with the present invention.

FIG. 5C is a view similar to FIG. 5B but illustrating the compression structure in a loaded and expanded condition.

FIG. 6 is a flow diagram of process steps of forming the compression structure of the present invention.

### DETAILED DESCRIPTION

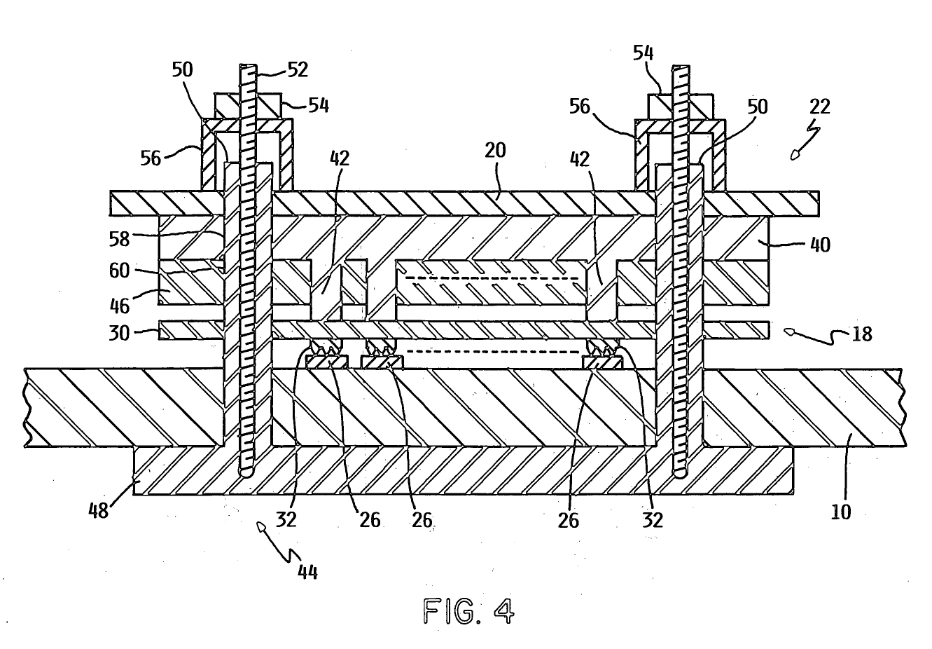

One preferred embodiment of the present invention is directed to an improved connector that can be used, for example, to connect a ribbon cable to contact fingers on an integrated circuit board. However, as will be pointed out, other compression structures are envisioned that may be particularly adapted to electrical connectors. FIG. 1 illustrates a first printed circuit board 10 having circuitry, such as integrated circuits 12 and a second printed circuit board 14 having circuitry, such as integrated circuits 16. A ribbon cable 18 having a plurality of parallel conductors (not shown in FIG. 1) carries signals between the circuitry of the first and second printed circuit boards 10 and 14, respectively. A clamping plate 20 of a connector 22 (see FIG. 4) connects the one end of ribbon cable 18 to the integrated circuits 16 on printed circuit board 10. Similarly, the other end of cable 18 is connected to the circuitry on the printed circuit board 14 by a connector 22 that includes the clamping plate 20.

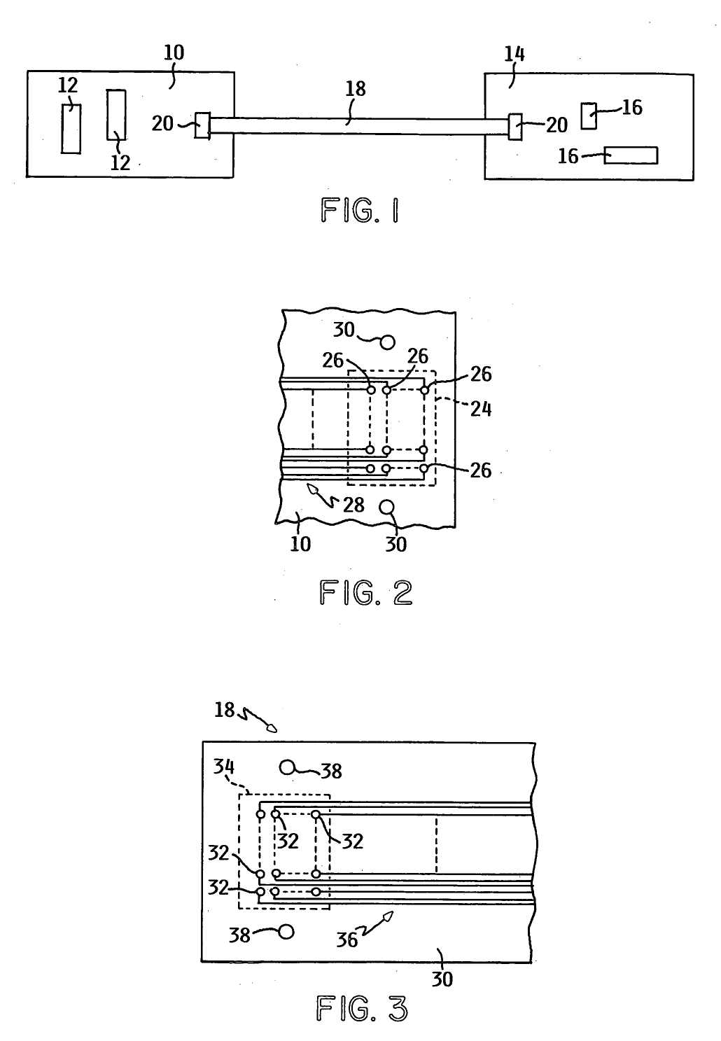

FIG. 2 illustrates a contact region 24 on the top side of printed circuit board 10. The contact region 24 contains an array of contact fingers 26. For purposes of illustration, the dotted lines depicted in FIG. 2 between the contact fingers 26 are intended to indicate that more contact fingers are typically present in the contact region 24 than are shown in FIG. 2. They have been removed for purposes of clarity. Printed wiring 28 connects the contact fingers 26 to the circuitry carried by the printed circuit board 10. Alignment holes 30 are adjacent to the ends of the contact region 24 of the printed circuit board 10.

FIG. 3 illustrates a bottom view of one end of the ribbon cable 18. It includes a flexible plastic strip 30 with an array of contact members 32 that are grouped within a contact region 34. For purposes of illustration, the dotted lines are used between the contact members 32 in FIG. 3 in order to indicate that more contact members are typically present than are actually shown in the drawing. Printed wiring 36 is carried by the strip 30 and is connected to the contact members 32. Although the printed wiring 36 in FIG. 3 is located on the same side of strip 30 as the contact members 32, the wiring 36 may be provided on the reverse side of the strip 30 and connected electrically to the contact members 32 by plated through-holes (not shown). The strip 30 is provided with an alignment hole 38 adjacent each end of the contact region 34. When the ribbon cable 18 is inverted and the alignment holes 38 are aligned with the alignment holes 38 in the printed circuit board 10, the contact region 34 will be aligned with the contact region 24 and the contact members 32 of the ribbon cable 18 will be positioned directly above corresponding contact fingers 26 on the printed circuit board 10.

With reference to FIGS. 2-4 together, the connector 22 includes the contact fingers 26, the contact members 32, an elastomeric compression structure or mat 40 having an array of compression fingers 42 that are located so as to force or press the electric contact component or members 32 against the electric contact fingers 26, and a clamping assembly 44 which forces or presses the compression structure or mat 40 toward the printed circuit board 10 or other electric component. This exerts a compressive force on the compression fingers 42, which act somewhat as springs. However, the compression structure or mat 40 and its compression fingers 42 are made of a flexible and resilient, elastomeric material. As noted above, elastomeric material has a tendency to relax over a period after it has been placed in a state of compression. It is believed that this tendency for the elastomeric material to relax is accompanied by a slight increase in the bulge of the compression fingers 42 or possibly a redistribution of the bulge. At any rate, the result is that the pressure forcing the contact members 32 against the contact fingers 26 would ordinarily be reduced after the clamping assembly 44 is originally tightened. In order to reduce the tendency of the elastomeric material to relax, the connector 22 may also include a restrainer member 46. The restrainer member 46 is made of a pliable material having a stiffness, or durometer measurement, which is smaller than that of the elastomeric material of the compression structure or mat 40. The restrainer member is similar to that described in commonly-assigned U.S. Pat. No. 6,814,589, and hence, a detailed description thereof is not believed necessary, but nevertheless the description is incorporated herein as a part hereof.

The purpose of the clamping assembly 44 is to force the elastomeric compression structure or mat 40 toward the printed circuit board 10. It will be apparent that there are many possible ways to achieve this purpose and that the clamping assembly 44 may take many forms. In the embodiment illustrated in FIG. 4, the clamping assembly 44 includes a clamp member 48 having two cylindrical alignment arms 50. Threaded metal bolts 52 are embedded in the alignment arms 50 and have outer portions that extend above them. The clamp member 48 may be made by an injection molding process.

The clamping assembly 44 also includes nuts 54 that screw onto the bolts 52 and cap elements 56 beneath the nuts 54. The cap elements 56 have disk-shaped upper surfaces with holes in them for passage of the bolts 52, and cylindrical skirts that extend downward to press against the clamping plate 20, which is also part of the clamping assembly 44. The clamping plate 20 has holes (not numbered) for passage of the alignment arms 50.

During assembly, the alignment arms 50 are threaded through the alignment holes 30 (see FIG. 2) of the printed circuit board 10, the alignment holes 38 (see FIG. 3) of the ribbon cable 18, alignment holes 58 and 60 in the compression structure or mat 40 and the restrainer member 46, respectively, and the holes in the clamping plate 20. The exposed outer portions of the threaded bolts 52 are threaded through the holes in cap elements 56 and the nuts 54 are screwed on to the bolts 52. The nuts 54 are then tightened to compress the compression fingers 42 so as to force the contact members 32 tightly against the contact fingers 26 to apply a given actuation or loading force.

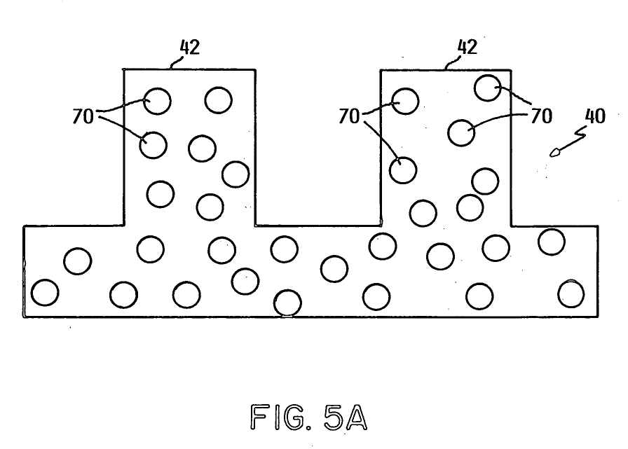

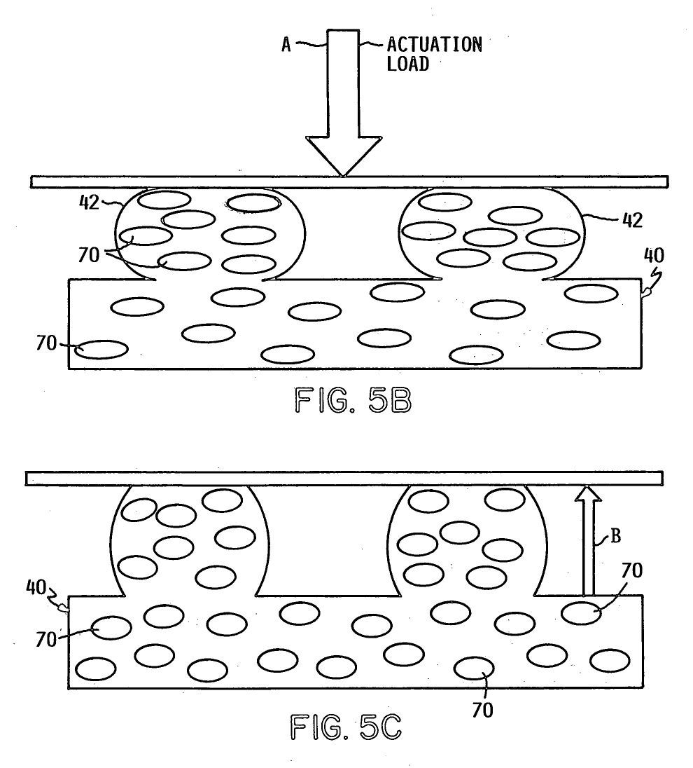

Illustrated in FIG. 5A is a schematic representation of a preferred elastomeric electrical compression structure or mat 40 with compression fingers 42 prior to being loaded. FIGS. 5B & 5C are illustrated representations of the loaded compression structure or mat 40 before and after expansion of the plurality of embedded gas-expandable members; respectively. FIG. 5B illustrates loading compression on the compression fingers 42 at ambient temperatures with concomitant deformation of the gas-expandable members, under a loading force indicated by the arrow A. FIG. 5C illustrates the gas within the gas-filled polymeric microspheres 70 after being expanded significantly, whereby such expansion of the latter and the polymeric base exert offsetting forces (arrow B) to the actuating load, thereby minimizing stress relaxation.

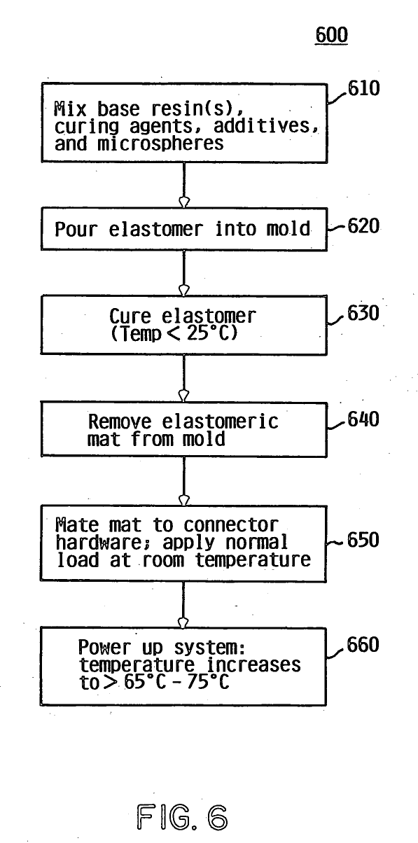

Reference is made to FIG. 6 for illustrating an exemplary embodiment of a process 600 utilized for making the electrical connection compression structure or mat 40. In step 610, a curable molding formulation is mixed with a plurality of gas-filled polymeric microspheres 70. The following Example represents one embodiment of a mixture that can be used for making the formulation used of the compression structure or mat 40. The noted mixture can be made from various other materials in various proportions. Preferably, the curable molding formulation includes a synthetic elastomer base resin, such as a silicone elastomer. One kind of silicone elastomer may be a fast-cure type, such as Sylgard® 170; a commercial silicone elastomer of Dow Corning. In one exemplary embodiment, the silicone elastomer may comprise about 50 grams; 50% by weight of the formulation (see Example 1 in Table I, infra).

EXAMPLE 1

| | Concentration | Cure |
|---|---|---|
| Constituents | (weight) | Condition |
| Silicone elastomer, | 50 wt. % | 24 hrs @ RT |
| Gas-filled polymeric microspheres, e.g., | 20 wt. % | |
| Expancel ® DU 820 | | |
| Platinum (0)-1,3 divinyl-1,1,3,3 tetra- | 3 wt. % | |
| methlydidiloxane, curing catalyst | | |
| Quartz filler | 17 wt. % | |
| dimethylvinyl terminated | 10 wt. % | |
| polydimethylsiloxane, curing agent | | |

While the base resin formulation may be a synthetic elastomer, the present invention is not limited thereto. Various other base resins or combinations thereof can be employed without deviating from the spirit of the present invention. This group includes, but is not limited to, silicone resins such as Sylgard 567, Sylgard 577, Sylgard 255, Dow Corning RTV 627, Dow Corning 3-6636 gel, Dow Corning 3-4155 HV gel, Dow Corning 3-6121, GE Silicones RTV 615 A/B, GE Silicones RTV 102, GE Silicones RTV 157; fluorosilicones such as GE Silicones FSE 2620U, GE Silicones FSE 3540, GE Silicones FSE 7140, GE Silicones FSL 7208, GE Silicones FSL 7210; two component, room temperature curable epoxy resins such as CLR1010 /CLH6020, CLR1030/CLH6450, CLR1066/CLH6590, CLR1336/XHD1326, CLR1556/CLH6640, available from Crosslink Technology, Inc.; and polyurethane potting compounds such as CLC 1A 005, CLC 1A 010, available from Crosslink Technologies, Inc. In addition to the commercially-available products listed above, suitable elastomer base resins may be from a group that includes vinyl-terminated polydimethylsiloxanes, hydride silanol-, amino-, epoxy-, and carbinol-terminated polydimethylsiloxanes. Other suitable elastomer base resins include natural rubber, styrene-butadiene rubbers, polybutadiene rubbers, isobutylene-isoprene rubbers, nitrile butadiene rubbers, polychloroprene neoprene, ethylene-propylene polymers, chlorosulfonated polyethylenes, chlorinated polyethylene, epichlorohydrin elastomers, acrylic elastomers, urethane elastomers, polysulfide elastomers, fluorosilicone elastomers, flourocarbon elastomers, copolyester ethers, and combinations thereof.

Suitable curing catalysts, such as platinum(0)-1,3-divinyl-1,1, 3,3 tetramethydisiloxane 3 wt. % (3 grams), suitable agents, such as dimethylvinyl terminated polydimethylsiloxane, 10 wt.% (10 grams) and suitable additives, such as quartz filler 17 wt. % (17 grams) may be added to make the electrical connector structure exhibit the desired properties intended for the uses envisioned. The additives and curing agents do not, per se, form part of the present invention insofar as they may be suitably altered consistent with known practices to achieve different functionalities.

The curable, molding silicone resin is mixed generally uniformly with the gas-filled polymeric microspheres 70. The gas-filled polymeric microspheres 70 are small, generally spherical plastic particles that encapsulate a gas. When heated, the gas causes the spherical plastic particles to expand significantly in volume. The amount and type of expandable microspheres utilized may each be readily varied to obtain the desired degree of expansion (typically, from about 5% to about 150%, more typically from about 35% to about 70%). The gas-filled polymeric microspheres 70 are formulated to be, preferably, generally uniformly dispersed in the curable molding formulation. The gas-filled polymeric microspheres come in many different grades, expanded or unexpanded, for a wide variety of applications. It has been determined from testing that if the gas-filled polymeric microspheres are expanded during curing that in response to being exposed to the operating conditions of the electrical connection, such microspheres will not provide a sufficient amount of offsetting force to relieve stress relaxation.

In the present embodiment, the gas-filled polymeric microspheres comprise about 20 grams or about 20 wt % of the total formulation in the Example 1 of Table I (supra). The gas-filled polymeric microspheres may be in a size range of about 6-38 μm in diameter. Other size ranges are contemplated for use. In the present embodiment, the gas-filled polymeric microspheres may be commercially available Expancel® DU 820 from Akzo Nobel.

The gas-filled polymeric microspheres 70 can also be selected from any of the following dry, unexpanded grades also available from Akzo Nobel, for example, from the following Expancel® grades: 551 DU 40, 551 DU 20, 551 DU 80, 461 DU 40 , 461 DU 20, 051 DU 40, 053 DU 40, 009 DU 80, 091 DU 40, 091 DU 80, 091 DU 140, 092 DU 40, 092 DU 80, 092 DU 120, 093 DU 120, 930 DU 120, 950 DU 80, 950 DU 120. The temperatures specified for gas expansion can be used to select the specific Expancel® grade of gas-filled polymeric microspheres 70 Aside from the foregoing commercially-available microspheres, the hollow microspheres can be prepared from compressible polymers or copolymers such as styrene acrylonitrile, poly(methyl methacrylate), poly(vinylidene chloride), poly(vinyl alcohol), polyaniline, polyimides, polyamides, polycarbonates, and silicones. The polymeric shells may be filled with a suitable gas from a group including isobutene and isopentane. Alternatively, a suitable blowing agent may be used for the gas-expandable members. The blowing agent is a compound that decomposes to a gas and expands above a certain trigger or onset temperature. Non-limiting examples of the latter include azodicarbonamides, p,p′-xybis(benzenesulfonyl hydrazide), p-toluene sulfonyl semicarbazide, p-toluene sulfonyl hydrazide, and dinitrosopentamethylene tetraamine. The onset temperature for gas expansion of the blowing agent in the illustrated embodiment is the operating temperature (e.g., 65° C. to 75° C.) of the compression structure 40. The onset temperature for gas expansion can be, of course, varied to meet the operating temperatures in which it is desired to be heated.

Reference is now made back to the process 600. In step 620, the above formulation is poured into a suitable curing mold cavity (not shown), known in the art for molding elastomeric members, such as compression structures or mats 40. While in this embodiment, the formulation is molded as the elastomeric compression structure or mat 40 having the configuration depicted in FIG. 5A, other configurations and sizes for the cured compression structures are contemplated.

In step 630, the above formulation ( Example 1) is cured at about room temperature (e.g., 25° C.), preferably, for a period of about 24 hrs. The temperature and curing times will, of course, vary depending on the formulations being cured. Curing is to be conducted consistent with procedures known to one of ordinary skill in the art. A variety of mechanisms (not shown) for controlling the curing may be utilized. The curing temperature range that is predefined is important since the gas-expandable members are to remain relatively unexpanded during curing of the base elastomer.

According to an illustrated invention, the gas-filled polymeric microspheres 70 are selected to remain substantially unexpanded while the elastomeric formulation is cured at room temperatures ( e.g., 25° C.). However, the gas-filled polymeric microspheres 70 are intended to expand significantly in response to the loaded formulation being placed in operating conditions having temperatures (e.g., 65° C.-75° C). Such operating conditions may be in the operating environment the electrical connection. As a consequence, the gas-filled polymeric microspheres 70 will increase significantly (e.g., 20-30%) in volume according to Example 1 under the above circumstances. The increase in the volume of the loaded formulation is, in large part, attributed to the volumetric increase of the gas-filled polymeric microspheres 70.

Expansion of the gas-filled polymeric microspheres 70 generates an offsetting outwardly expanding force in opposition to the loading force (see arrow B in FIG. 5C). This offsetting force acts to overcome the negative effects of stress relaxation of the elastomeric compression fingers that would otherwise be experienced in the working environment. While the present embodiment discusses that the gas-filled polymeric microspheres remain substantially unexpanded during curing, such need not be the case in all situations.

An alternative embodiment involves curing the base elastomer at temperatures (e.g., >75° C. to about 125° C.) above the operating temperature (e.g., 65° C. -75° C.) in which the loaded formulation operates. In such embodiment, it is preferred to have the curing performed under pressure that is sufficient to offset gas expansion of the gas-filled polymeric microspheres during curing. As a result, the gas-filled polymeric microspheres remain substantially unexpanded during curing. In this embodiment, the amount of pressure added to prevent expansion is in a range of about 1 atm. to about 1.5 atm. Alternative pressures higher than 1.5 atm. can be used and may range upto about 5 atm. At the higher pressures, it will be realized that the gas-filled polymeric microspheres will be compressed and reduced in volume during curing. This allows for even more expansion of the gas-filled polymeric microspheres 70 after curing when the added pressure is relieved.

Still another alternative embodiment has the formulation cured at temperatures below the operating temperature, but under additional pressure sufficient to cause the gas-expandable members to substantially remain in a state of compression during curing, whereby their volume is diminished. In this embodiment, the amount of pressure added to prevent expansion may be in a range of about 1 atm. to about 1.5 atm. Other higher pressures are envisioned and this allows for even more expansion of the gas-filled polymeric microspheres 70 after curing when the added pressure is relieved.

In step 640, the cured compression structure or mat 40 is removed from the mold and can be used in the manner described. Tests were conducted with the cured elastomeric mat 40. In general, the cured elastomeric mat 40 retained about greater than 95% of the force generated by the applied compressive load (e.g. 30 lbs). by the electrical structure depicted in FIG. 4. It will be appreciated the results will vary depending on the formulations and loading conditions.

In step 650, the cured compression structure or mat 40 is joined to the electrical connection as viewed in FIG. 4 and loaded as noted to for effecting a reliable electrical connection.

In step 660, the system is powered up. As a result, the loaded compression structure or mat 40 reaches its operating temperature (e.g., 65° C. -75° C.) that exceeds the predefined curing temperature range (e.g., 25° C.) of the formulation. Accordingly, the base elastomer and the gas-expandable members expand by an amount sufficient to reduce stress relaxation of the loaded formulation.

The embodiments and examples set forth herein were presented in order to explain best the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method of forming an elastomeric compression structure, the method comprising: providing a formulation including a base elastomer and a plurality of gas-expandable members dispersed within the base elastomer, wherein the gas-expandable members remain substantially unexpanded while the formulation is cured in a predefined curing temperature range; loading the cured formulation under compression and, heating the loaded formulation to operating temperatures in which the loaded formulation operates to cause the base elastomer and the gas-expandable members to expand by an amount sufficient to reduce stress relaxation of the loaded formulation.

2. The method of claim 1 wherein the predefined curing temperature range of the formulation is below operating temperatures in which the loaded formulation operates, whereby expansion of the gas-expandable members and base elastomer occur in response to the loaded formulation being heated to its operating temperatures following curing.

3. The method of claim 1 wherein the predefined curing temperature range of the formulation is above operating temperatures in which the loaded formulation operates, but curing is performed under pressure sufficient to offset expansion of the gas-expandable members during curing, whereby expansion of the gas-expandable members occurs in response to the loaded formulation being heated to its operating temperatures following curing with the added pressure being relieved.

4. The method of claim 2 wherein the predefined curing temperature range of the formulation is below operating temperatures in which the loaded formulation operates, but curing is under pressure sufficient to cause the gas-expandable members to substantially remain in a state of compression during curing, whereby expansion of the gas-expandable members occurs in response to the loaded formulation being heated to its operating temperatures following curing with the added pressure being relieved.

5. The method of claim 1 wherein the gas-expandable members include gas-filled polymeric microspheres.

6. The method of claim 5 wherein the gas-filled polymeric microspheres are from a group including styrene acrylonitrile, poly (methyl methacrylate), poly (vinylidene chloride), poly (vinyl alcohol), polyaniline, polyimides, polyamides, polycarbonates, and silicones.

7. The method of claim 5 wherein the gas of the gas-filled polymeric microspheres is from a group including isobutene, and isopentane.

8. The method of claim 1 wherein the base elastomer is from a group of materials comprising elastomeric base resins, synthetic elastomers, vinyl-terminated polydimethylsiloxanes, hydride silanol-, amino-, epoxy-, and carbinol-terminated polydimethylsiloxanes, natural rubber, styrene-butadiene rubbers, polybutadiene rubbers, isobutylene-isoprene rubbers, nitrile butadiene rubbers, polychloroprene neoprene, ethylene-propylene polymers, chlorosulfonated polyethylenes, chlorinated polyethylene, epichlorohydrin elastomers, acrylic elastomers, urethane elastomers, polysulfide elastomers, fluorosilicone elastomers, flourocarbon elastomers, copolyester ethers, and combinations thereof.

9. The method of claim 5 wherein the gas-filled polymeric microspheres are in a size range of about 6-38 μm.

10. The method of claim 1 wherein the gas-expandable members include a blowing agent that has an onset temperature that is within the operating temperatures in which the loaded formulation operates.

11. An elastomeric compression structure that is made by providing a formulation including a base elastomer and a plurality of gas-expandable members dispersed within the base elastomer; curing the formulation cured in a predefined curing temperature range wherein the gas-expandable members remain substantially unexpanded; loading the cured formulation under compression; and, heating the loaded formulation to operating temperatures in which the loaded formulation operates to cause the base elastomer and the gas-expandable members to expand by an amount sufficient to reduce stress relaxation of the loaded formulation.

12. The structure of claim 11 wherein the predefined curing temperature ranges of the formulation is below operating temperatures in which the loaded formulation operates, whereby expansion of the gas-expandable members is in response to the loaded formulation being heated to its operating temperatures following curing.

13. The structure of claim 11 wherein the predefined curing temperature range of the formulation is above operating temperatures in which the loaded formulation operates, but curing is performed under pressure sufficient to offset expansion of the gas-expandable members during curing, whereby expansion of the gas-expandable members occurs in response to the loaded formulation being heated to its operating temperatures following curing and the added pressure being relieved.

14. The structure of claim 11 wherein the formulation is cured at temperatures below the operating temperatures in which the loaded formulation operates, but under additional pressure so that the gas-expandable members are cured in a state of compression, whereby expansion of the gas-expandable members is in response to the loaded formulation being heated to its operating temperatures following curing and the added pressure being relieved.

15. The structure of claim 11 wherein gas-expandable members include gas-filled polymeric microspheres.

16. The structure of claim 15 wherein the gas-filled polymeric microspheres include a group of unexpanded hollow microspheres including a group of compressible polymers or copolymers comprising styrene acrylonitrile, poly(methyl methacrylate), poly(vinylidene chloride), poly(vinyl alcohol), polyaniline, polyimides, polyamides, polycarbonates, and silicones.

17. The structure of claim 11 wherein the gas-filled polymeric microspheres may be gas-filled from a gas group including isobutene, isopentane, and a blowing agent.

18. The structure of claim 11 wherein the base elastomer is made of a material from a group including elastomeric base resins, synthetic elastomers, vinyl-terminated polydimethylsiloxanes, hydride silanol-, amino-, epoxy-, and carbinol-terminated polydimethylsiloxanes, natural rubber, styrene-butadiene rubbers, polybutadiene rubbers, isobutylene-isoprene rubbers, nitrile butadiene rubbers, polychloroprene neoprene, ethylene-propylene polymers, chlorosulfonated polyethylenes, chlorinated polyethylene, epichlorohydrin elastomers, acrylic elastomers, urethane elastomers, polysulfide elastomers, fluorosilicone elastomers, flourocarbon elastomers, copolyester ethers, and combinations thereof.

19. The structure of claim 12 wherein the gas-expandable members include a blowing agent that has an onset temperature that is within the operating temperatures in which the loaded formulation operates.

20. (canceled)
